(19) United States
(12) Patent Application Publication
(10) Pub. No.: US 2025/0227254 A1
(43) Pub. Date: Jul. 10, 2025

(54) SYSTEMS AND METHODS FOR REGION DETECTION AND REGION PACKING IN VIDEO CODING AND DECODING FOR MACHINES

(71) Applicant: OP Solutions LLC, Amherst, MA (US)

(72) Inventors: Hari Kalva, Boca Raton, FL (US); Borivoje Furht, Boca Raton, FL (US); Velibor Adzic, Canton, GA (US); Alena Krause, Coconut Creek, FL (US)

(73) Assignee: OP Solutions LLC, Amherst, MA (US)

(21) Appl. No.: 19/089,533

(22) Filed: Mar. 25, 2025

Related U.S. Application Data
(63) Continuation of application No. PCT/US2023/033662, filed on Sep. 26, 2023.
(60) Provisional application No. 63/409,843, filed on Sep. 26, 2022.

(51) Int. Cl. H04N 19/167; H04N 19/169

(52) U.S. Cl. CPC H04N 19/167; H04N 19/188

(57) ABSTRACT

A video encoder for encoding data for machine consumption includes a region detector selection module receiving source video and detector selection parameters and selecting an object detector model. A region detection module applies a selected model to the source video to identify regions of interest in the source video. A region extractor module extracts the identified regions from the source video and a region packing module packs the extracted regions into a packed frame which excludes pixels outside the regions of interest. A video encoder receives the packed frames and data related to the region parameters required to recreate the frame and generates an encoded bitstream. The encoder and encoding methods also include region padding and region merge and region split processing. Compatible decoders and bitstreams are also provided.

### CROSS-REFERENCE TO RELATED APPLICATIONS

The present application is a continuation of international application PCT/US23/33662, filed on Sep. 26, 2023, and entitled Systems and Methods for Region Detection and Region Packing in Video Coding and Decoding for Machines, which international application claims the benefit of priority to U.S. Provisional Application Ser. No. 63/409,843 filed on Sep. 26, 2022, and entitled “System and Method for Adaptive Region Detection and Region Packing,” and also claims the benefit of priority of U.S. Provisional Application Ser. No. 63/409,847 filed on Sep. 26, 2022, and entitled “System and Method for Extending Predicted Object Boundaries in a Video Packing System,” and further claims the benefit of priority of U.S. Provisional Application Ser. No. 63/409,851 filed on Sep. 26, 2022, and entitled “Systems and Methods for Merge and Split Region Extraction in Video Region Packing,” the disclosures of each which are hereby incorporated by reference in their entireties.

### FIELD OF THE DISCLOSURE

The present disclosure generally relates to the field of video encoding and decoding and in particular, encoding and decoding video and other data for machines.

### BACKGROUND OF THE DISCLOSURE

Recent trends in robotics, surveillance, monitoring, Internet of Things, etc. have introduced use cases in which a significant portion of all the images and videos that are recorded in the field is consumed by machines only, without ever reaching human eyes. Those machines process images and videos with the goal of completing specific tasks such as object detection, object tracking, segmentation, event detection etc. Recognizing that this trend is prevalent and will only accelerate in the future, international standardization bodies have established efforts to standardize image and video coding that is primarily optimized for machine consumption. For example, standards like JPEG AI and Video Coding for Machines have ongoing efforts in addition to already established standards such as Compact Descriptors for Visual Search, and Compact Descriptors for Video Analytics. Solutions that improve efficiency compared to the classical image and video coding techniques are needed and are presented herein.

### SUMMARY OF THE DISCLOSURE

In one embodiment, a video encoder for encoding data for machine consumption is provided. The video encoder includes a region detector selection module receiving source video and detector selection parameters and selecting an object detector model. A region detection module applies the selected model to the source video to identify regions of interest in the source video. A region extractor module extracts the pixels for the identified regions from the source video. A region packing module receives the extracted regions from the source video and packs those regions into a packed frame in which pixels outside the regions of interest are omitted. A region parameter module receives the identified regions from the region extractor and provides parameters for placing the regions of interest in a reconstructed video frame. A video encoder receives the packed frame from the region packing module and region parameters from the region parameter module and generates an encoded bitstream.

In some embodiments, the region detector selection module selects one of a plurality of models based on detector selection parameters from a machine task system. The detection selection parameters from the machine task system may be updated based on the performance of the machine task system to the encoded bitstream.

In certain embodiments, the detector models may include at least one of a RetinaNet model and a Yolov7 model.

The region detection module may define each detected region at least in part by a rectangular bounding box. In some embodiments, the encoder may include a region padding module which adds a padding parameter to one or more dimensions of a bounding box of a detected region. Each detected region may have an associated region type and the padding parameter may be determined at least in part based on the object type. Alternatively or additionally, the padding parameter may be determined at least in part on the region size and/or bounding box size.

In another embodiment, the encoder may include a merge split region extractor module which further processes detected regions and performs at least one of selectively merging regions with substantial overlap and selectively splitting regions to optimize packing performance. The merge split region extractor module can receive adaptive extraction parameters from a machine task system and dynamically adjusts merge and split parameters based on said parameters.

In certain embodiments the encoder may include both a region padding module and a merge split region extractor module.

A method of encoding video data for consumption by machine processing is provided which includes the steps of receiving source video; identifying at least one region of interest in the source video, each region of interest defined by an associated bounding box; extracting identified content of the regions of interest within the associated bounding box from the source video; packing the extracted regions into a packed video frame in which pixels outside the regions of interest are omitted; providing region parameters for the bounding boxes sufficient to reconstruct the regions of interest in a reconstructed video frame; and generating an encoded bitstream including the packed frame and associated region parameters.

In some cases the method may further include for at least one region of interest, applying region padding to at least one dimension of the associated bounding box. The method may further include merge split processing comprising including at least one of selectively merging regions of interest with substantial overlap and selectively splitting regions to optimize packing performance. A region of interest may have an associated object type and the region padding may be determined at least in part on the object type. In some embodiments, a region of interest has an associated bounding box size and the region padding is determined at least based on the bounding box size.

In some embodiments, the method may include receiving performance data from a machine system at a decoder site receiving the encoded bitstream and the region padding is determined at least in part based on the received performance data.

The present disclosure also includes a video decoder comprising circuitry configured to receive and decode an encoded bitstream generated by the above-described encoders and encoding methods. The present disclosure further discloses embodiments of computer readable media on which an encoded bitstream is stored, the encoded bitstream being generated by any of the encoders and encoding methods described herein.

These and other aspects and features of non-limiting embodiments of the present invention will become apparent to those skilled in the art upon review of the following description of specific non-limiting embodiments in conjunction with the accompanying drawings.

### BRIEF DESCRIPTION OF THE FIGURES

For the purpose of illustrating the invention, the drawings show aspects of one or more embodiments of the invention. However, it should be understood that the present invention is not limited to the precise arrangements and instrumentalities shown in the drawings, wherein:

FIG. 1 is a simplified block diagram of a system for encoding and decoding video for machines, such as in a system for Video Coding for Machines (VCM).

FIG. 2 is a simplified block diagram of a system for encoding and decoding video for machines, such as Video Coding for Machines (“VCM”), with region packing in accordance with the present methods.

FIG. 3 is a pictorial diagram comparing inference prediction using two different object detection networks;

FIG. 4 is a simplified block diagram of an alternate embodiment of an encoder for video for machines with both region packing and region padding in accordance with the present methods;

FIG. 5 is a pictorial diagram illustrating an example for region padding in accordance with the present disclosure;

FIG. 6 is a simplified block diagram of an alternate embodiment of an encoder for encoding video content for machines, such as Video Coding for Machines (“VCM”), with region packing and merge and split extraction processing in accordance with the present methods;

FIG. 7 is a simplified block diagram further illustrating the merge/split region extractor module of the encoder of FIG. 6; and

FIG. 8 is a pictorial diagram illustrating objects identified using merge/split region extraction in accordance with the disclosed systems and methods.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DESCRIPTION OF EXEMPLARY EMBODIMENTS

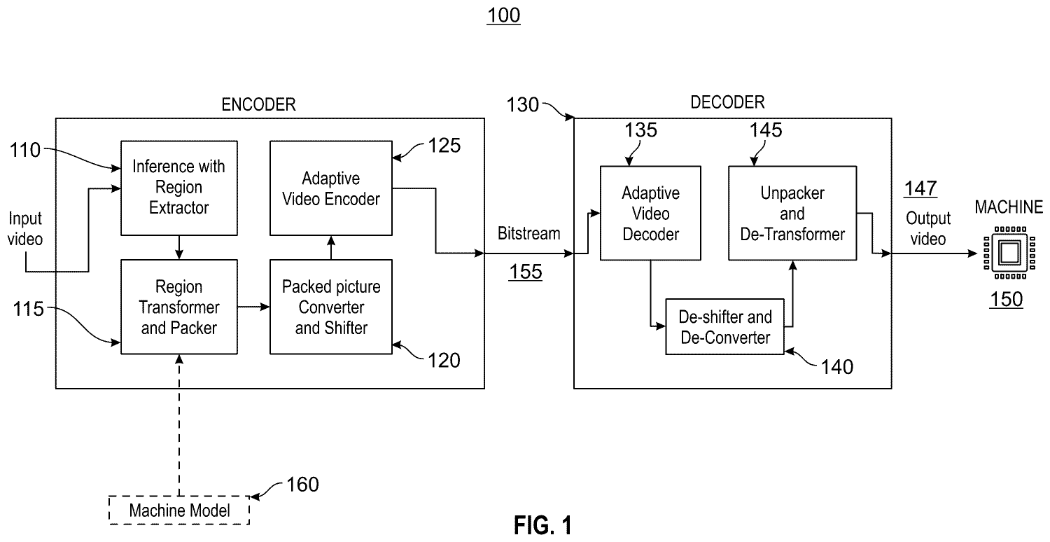

FIG. 1 is a block diagram illustrating an exemplary embodiment of a system comprising of an encoder, a decoder, and a bitstream well suitable for machine-based consumption of video and related data, such as contemplated in applications for Video Coding for Machines (“VCM”). While FIG. 1 has been simplified to depict the components used in coding for machine consumption, it will be appreciated that the present systems and methods are applicable to hybrid systems which also encode, transmit and decode video for human consumption as well. Such systems for encoding/decoding video for various protocols, such as HEVC, VVC, AV1, and the like, are generally known in the art.

Referring now to FIG. 1, an exemplary embodiment of a coding system 100 comprising of an encoder 105, a bitstream 155, and a decoder 130 is illustrated.

Further referring to FIG. 1, an exemplary embodiment of an encoder for coding video for machines is shown. Encoder 105 may be implemented using any circuitry including without limitation digital and/or analog circuitry; encoder 105 may be configured using hardware configuration, software configuration, firmware configuration, and/or any combination thereof. Encoder 105 may be implemented as a computing device and/or as a component of a computing device, which may include without limitation any computing device as described below. In an embodiment, encoder 105 may be configured to receive an input image or video data 102 and generate an output bitstream 155. Reception of an input video 102 may be accomplished in any manner described below or known in the art. A bitstream may include, without limitation, header content, payload content, supplemental signaling information, and the like, and may comprise any bitstream as described below.

Encoder 105 may include, without limitation, an inference with region extractor 110, a region transformer and packer 115, a packed picture converter and shifter 120, and/or an adaptive video encoder 125.

The Packed Picture Converter and Shifter 120 processes the packed image so that further redundant information may be removed before encoding. Examples of conversion are conversions of color space, (e.g. converting from the RGB to grayscale), quantization of the pixel values (e.g. reducing the range of represented pixel values, and thus reducing the contrast), and other conversions that remove redundancy in the sense of machine model. Shifting entails the reduction of the range of represented pixel values by direct right-shift operation (e.g. right-shifting the pixel values by 1 is equivalent to dividing all values by 2). Both conversions and shifting processes are reversed on the decoder side by block 140, using the inverse mathematical operations to the ones used in 120.

Further referring to FIG. 1, adaptive video encoder 125 may include, without limitation, any video encoder as described in further detail below or otherwise known in the art for encoding video to an advanced CODEC standard such as HEVC, AV1, VVC and the like.

Still referring to FIG. 1, and exemplary embodiment of decoder 130 is illustrated. Decoder 130 may be implemented using any circuitry including without limitation digital and/or analog circuitry; decoder 130 may be configured using hardware configuration, software configuration, firmware configuration, and/or any combination thereof. Decoder 130 may be implemented as a computing device and/or as a component of a computing device, which may include without limitation any computing device as described below. In an embodiment, decoder 130 may be configured to receive an input bitstream 155 and generate an output video 147 suitable for machine consumption. Reception of a bitstream 155 may be accomplished in any manner described below or otherwise known in the art. A bitstream may include, without limitation, a compatible bitstream provided by encoder 105 having, for example, header information, payload data, enhanced or supplemental signaling, and the like, and/or may comprise any bitstream as described below.

With continued reference to FIG. 1, a machine model 160 may be present in the encoder 105, or otherwise provided to the encoder 105 in an online or offline mode using an available communication channel. Machine model 160 is application/task specific and generally contains information sufficient to describe requirements for task completion by machine 150 at the decoder site. This information can be used by the encoder 105, and in some embodiments specifically by the region transformer and packer 115.

Given a frame of a video or an image, effective compression of such media can be achieved by detecting and extracting its important regions and packing them into a single frame. Simultaneously, the system discards any detected regions that are not of interest. These packed frames serve as input to an encoder to produce a compressed bitstream. The produced bitstream 155 contains the encoded packed regions along with parameters needed to reconstruct and reposition each region in the decoded frame. A machine task system 150 can perform tasks such as designated computer vision related functions on the reconstructed video frames.

Such a video compression system can be improved by enabling adaptive selection of region detection methods. Adaptively selecting which encoder-side region detection system to use is beneficial in supporting the endpoint target machine task.

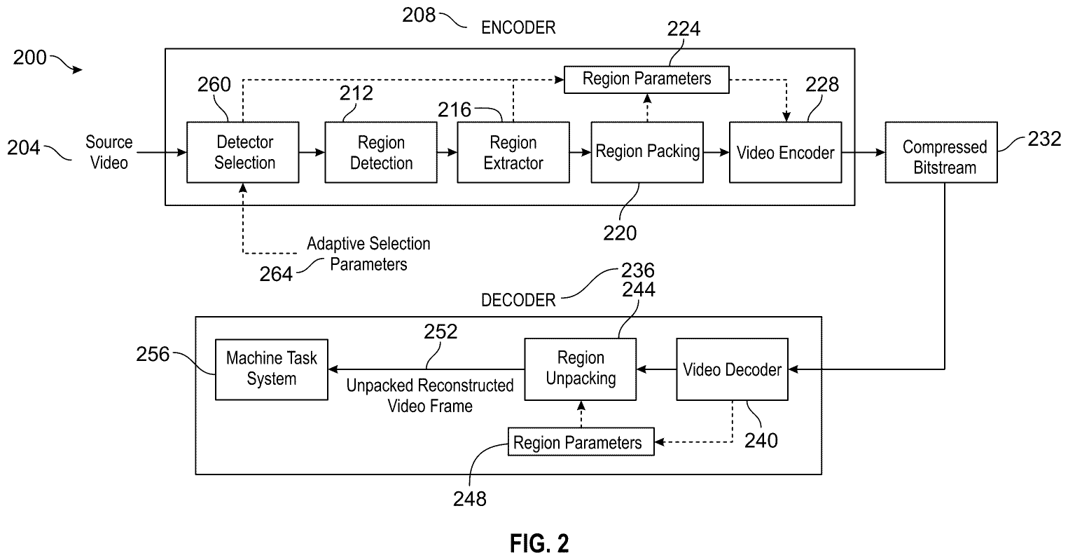

FIG. 2 is a simplified block diagram of a system for video coding and decoding for machines with region packing in accordance with the present disclosure. Referring to FIG. 2, the system 200 is comprised of an encoder 208 and decoder 236. The encoder includes a detector selection block 260 which receives the source video 204 and adaptive selection parameters 264 for the machine-task system. The encoder further includes region detection block 212, region extractor module 216, region packing module 220, region parameters 224, and video encoder 228 which cooperate to generate a compressed bitstream 232, which is passed over a communication channel to the decoder site which decodes the bitstream for processing by the machine task system 256.

The decoder 236 includes a video decoder 240 which receives the compressed bitstream 232, region unpacking module 244, and region parameters 248 which generate unpacked reconstructed video frames 252 for the machine task system 256.

### Encoder Site Region Detection

Significant frame or image regions are identified using the detection system 212 which produces coordinates of discovered objects. Resulting coordinates are used to determine regions for packing and enable the identification of pixels deemed as unimportant to the detection module. Such unimportant regions may be discarded and need not be used in packing.

Improvements to the region detection module 212 within the compression pipeline aim to better support target machine task performance. The adaptive selection methodology described herein provides that the encoder-side detection algorithm may be chosen based on specified characteristics of the endpoint evaluation network. For example, a neural network can be chosen that matches a neural network with similar characteristics used by the machine, e.g., a convolutional neural network with similar number of layers and input and output dimensions. In some examples an identical algorithm can be used. If the information about the detection algorithm that the machine 150 uses is not available, or does not contain detailed description, or the algorithm itself is not available for implementation on the encoder side, a similar algorithm can be used. In some cases, a similar but more recent algorithm can be used as a substitute on the encoder side to allow faster operation.

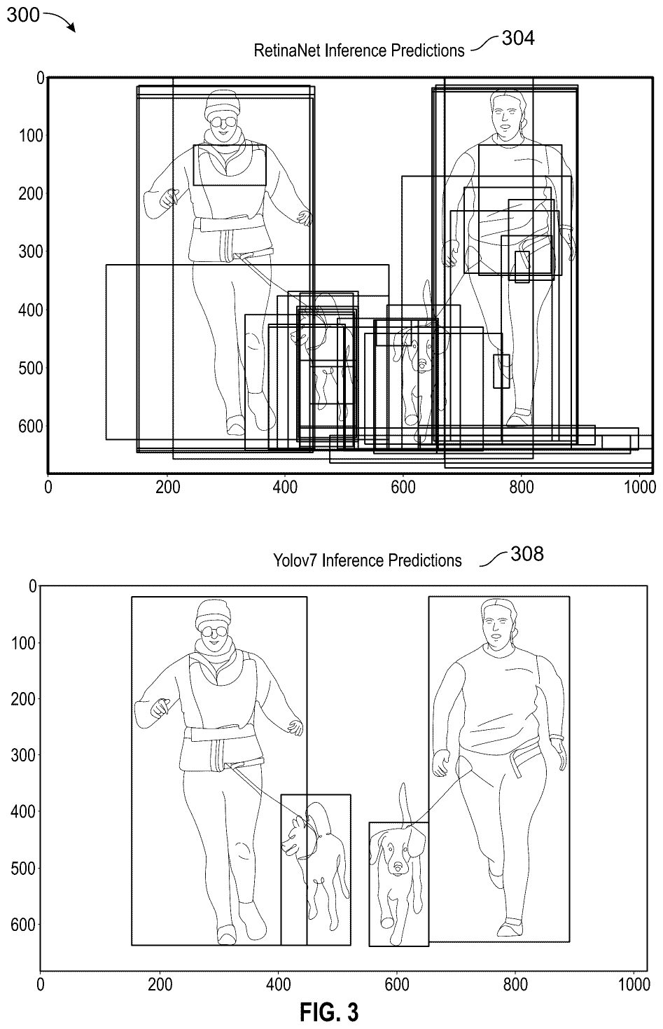

FIGS. 3A and 3B show an exemplary image with inference predictions created by two distinct object detection networks. In FIG. 3A, inference predictions 304 are derived from the Detectron2's RetinaNet model while FIG. 3B illustrates the 308 inference prediction coordinates which are output from the Yolov7 network. The RetinaNet model is described in Lin, T. Y., Goyal, P., Girshick, R., He, K., & Dollár, P. (2017), Focal Loss for Dense Object Detection published in Proceedings of the IEEE international conference on computer vision (pp. 2980-2988). The Yolov7 network is described in Wang, C. Y., Bochkovskiy, A., & Liao, H. Y. M. (2022), YOLOv7: Trainable Bag-of-Freebies Sets New State-of-the-art for Real-time Object Detectors, arXiv preprint arXiv:2207.02696. It will be appreciated that these are merely examples of suitable detection networks and the present systems and methods are not limited to these specific detection networks.

It will be appreciated by those skilled in the art that in applying the proposed methods, one particular detection network may be preferred over others based on particular target machine task. Returning to FIG. 2, the presently disclosed CODEC pipeline preferably sends adaptive selection parameters 264 of the target machine task to detector selection module 260. Detector selection module 260 interprets the received information and uses it to select the best available detection network. The preferred detection network is one which provides optimal region detection to support endpoint computer vision related tasks in 256. For example, an endpoint neural network task system that is highly sensitive to object context may yield the selection of RetinaNet detection method, as more background pixels are included in the image. Contrastingly, a system which aims to reduce the size of the transmitted bitstream 232 may choose the Yolov7 model as it contains less predictions, as illustrated in FIGS. 3A and 3B respectively.

The selected detection method along with the information that characterizes the detection method may be included in the output bitstream 232. Such information can be signaled in the bitstream header or provided as supplemental information in the bitstream. In some embodiments, this can be included in the sequence parameter set (“SPS”) data that usually remains unchanged for a sequence of frames or included in picture parameter set (“PPS”) data that could change over frames. Detection method information include detection method use, version number of the detection method, training data used in the detection method, performance parameters such as minimum and maximum detection confidence for detection in a frame, object classes detected in a frame. Detection confidence for each object class may also be included in the bitstream. Other parameters that characterize detection performance can be determined and included. At the decoder, the model parameters extracted from the bitstream may be used to select or adapt the machine/algorithm used for the machine task.

### Object Detector Information

The following is a description of exemplary object detection semantics that can be encoded in the bitstream

| | Descriptor |
|---|---|
| object_detector_information( ) { | |
| object_detector_ID | u(8) |
| object_detector_version | u(16) |
| object_detector_name_length | u(8) |
| object_detector_name [object_detector_name_length] | u(8)*object_detector |
| | _name_length |
| object_classes_detected | u(8) |
| for(i=0; i< object_classes_detected_minus1;i++){ | |
| min_detection_condfidence | u(8) |
| max_detection_condfidence | u(8) |
| object_class_name_length | u(8) |
| object_class_name[object_class_name_length] | u(8) |
| } | |
| } | |

### Object Detector Information Semantics

object_detector_ID—ID of the object detector. This ID may be from a known detector registration authority or may be configured and agreed upon between the encoding and decoding systems.

object_detector_version—version of the object detector. Object detector version may be used to identify how a specific detector is trained. Additional information such as number of classes the detector can handle can be obtained based on the version number. This bitstream field can be extended include a list of classes the detection can detect.

object_detector_name_length—number of bytes used for the object detector name

object_detector_name [object_detector_name_length]—name of the object detector. This is usually a displayable string.

object_classes_detected—number of object classes detected in this frame.

min_detection_condfidence—confidence described as a number between 0 and 100. 100 is 100% confidence and 0 is 0% confidence.

max_detection_condfidence—confidence described as a number between 0 and 100. 100 is 100% confidence and 0 is 0% confidence.

object_class_name_length—number of bytes used for the object class name
object_class_name [object_class_name_length]—name of the object class

| | Descriptor |
|---|---|
| sequence_parameter_set ( ) { | |
| .. | |
| .. | |
| object_detector_information_present | u(1) |
| if(object_detector_information_present){ | |
| object_detector_information( ); | u(8) |
| } | |
| .. | |
| .. | |

object_detector_information_present—a one bit field, when set to 1, signals the presence of object_detector_information in the sequence parameter set (“SPS”).

| | Descriptor |
|---|---|
| Picture_parameter_set ( ) { | |
| .. | |
| .. | |
| object_detector_information_present | u(1) |
| if(object_detector_information_present){ | |
| object_detector_information( ); | u(8) |
| } | |
| .. | |
| .. | |

object_detector_information_present—a one bit field, when set to 1, signals the presence of object_detector_information in the picture parameter set (“PPS”).

Similarly, such object detector information may be extended or reduced and signaled in other places in a video bitstream such as the slice header. In some cases, such object detection information can be signaled as supplementary enhancement information (SEI) data that may be associated with the frame and signaled in a separate information packet that is not included in the video bitstream.

The selected method for object detection along with any specification information, serves as input to the region detector module 212. The signaled method from machine system 256 along with any selection parameters 264 are used to perform inference and identify regions in 212. Additional region extraction methodologies may be paired with the proposed adaptive system. These steps may be used to isolate the best possible combinations of region detection predictions, derived from specified characteristics. That is, based on the detection network chosen, different thresholds for box selection may be applied based on the characteristics of the network. This includes thresholding of box confidence to keep high/low/all confidence predictions or additionally using class-based methods to select regions based on its inferred category from the network.

Table 1 shows the difference in performance between the previously mentioned RetinaNet and Yolov7 detection networks. From the table, it may be concluded that such a region packing system may be influenced by the inference predictions derived from 212. Thus, the inclusion of selection module 260 benefits the system as it allows performance to be improved through adaptive selection of detection methods.

TABLE 1
Comparison of Detection Methods in a Region Packing System
100% Resolution

| | Yolov7 Network | | Detectron2 RetinaNet Network | | Original | |
|---|---|---|---|---|---|---|
| | With Region Packing | | With Region Packing | | Raw Source Frames | |
| QP | BPP | mAP | BPP | mÅP | BPP | mAP |
| 22 | 0.620759418 | 0.80147 | 0.707320271 | 0.803108 | 0.841 | 0.80536 |
| 27 | 0.364342718 | 0.795638 | 0.414055366 | 0.797256 | 0.493 | 0.80197 |
| 32 | 0.206152411 | 0.781394 | 0.234576105 | 0.78407 | 0.277 | 0.78775 |
| 37 | 0.112577631 | 0.749274 | 0.127868956 | 0.752748 | 0.147 | 0.75653 |
| 42 | 0.059212221 | 0.687059 | 0.066647743 | 0.690148 | 0.074 | 0.69917 |
| 47 | 0.029979605 | 0.566119 | 0.033312978 | 0.560812 | 0.036 | 0.57773 |
| | BD-rate | BD-mAP | BD-rate | BD-mAP | | |
| | −11.12% | 0.901351102 | −2.74% | 0.227282 | | |

### Region Extraction and Packing

The resulting coordinates from region detection system 212 serve as input to region extraction system 216. The extraction module 216 extracts the significant image regions and prepares the coordinates for the packing module 220. The packing module 220 receives the extracted region and packs them tightly into a single frame. The module additionally outputs packing parameters that will be signaled later in bitstream 232.

### Video Encoding

Packed object frames are processed through video encoder 228 to produce a compressed bitstream 232. The compressed bitstream includes the encoded packed regions along with parameters 224 needed to reconstruct and reposition each region in the decoded frame. Video encoder 228 can take the form of any known advanced video encoder known for use in encoding standards such as HEVC, AV1, and VVC, or variations on such known encoders. Optionally, any detection thresholds applied along with the network selected by the detection module may be signaled in the 232 bitstream for use in 236 decoder side reconstruction.

### Video Decoding

The compressed bitstream 232 is decoded using video decoder 240 to produce a packed region frame along with its signaled region information. Video decoder 240 will generally take the form which is complimentary to the selected video encoder 228 and can take the form of any known advanced video decoder known for use in conventional codec standards such as HEVC, AV1, and VVC, or variations on such known standards. The signaled region information includes parameters needed for reconstruction of the frame and may incorporate the signaled detection thresholds and methods used for each of the regions applied in the encoder 208.

### Region Unpacking

Region parameter module 248 provides the decoded region parameters to unpack the region frames via region unpacking module 244. During region unpacking each box is returned to its position within the context of the original video frame. The resulting unpacked frame only includes the significant regions determined by region detection system 212 and does not include the discarded pixels. These unpacked regions include the predictions made by the adaptively selected detection network in encoder 208.

### Machine Task

The unpacked and reconstructed video frame 252 is used as input to machine task system 256 which performs a specified machine task such as computer vision related functions. Machine task performance on the regions selected by the 260-selection module may be analyzed to determine optimal box selection methods and inference thresholds on a case-by-case scenario. Optimized region detection parameters 264 may be altered and signaled to the encoder side pipeline in order to more effectively select region detection methods.

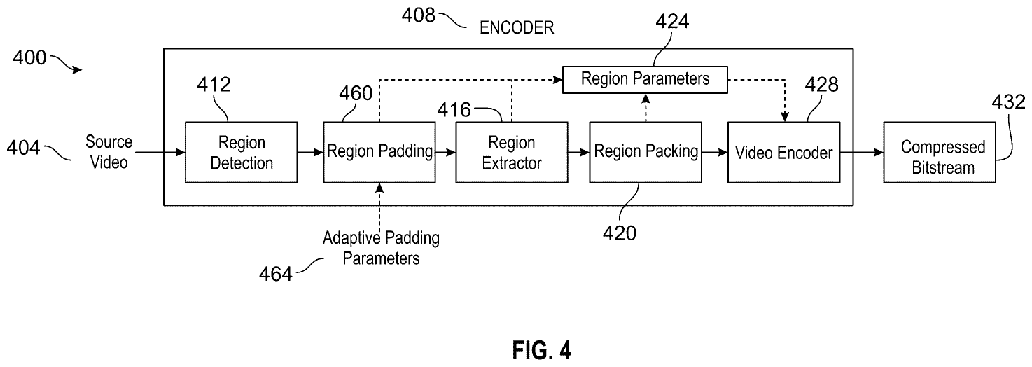

FIG. 4 is a simplified block diagram of an encoder for region packing with region padding in s system for video encoding for machines in accordance with the present disclosure. Region padding is a process of extending the boundaries of detected regions to improve system performance. Encoder 408 includes a region detector 412 and a region padding module 460 which receives the source video 404 from the region detector 412 and adaptive padding parameters 464 for the machine-task system. The encoder 408 further includes region extractor module 416, region packing module 420, region parameters 424, and video encoder 428 which cooperate to generate a compressed bitstream 432, each of which are substantially similar in structure and operation to those corresponding components as described above in connection with FIG. 2, except as noted below.

### Region Detection

Significant frame or image regions are identified using the encoder side region detector module 412, which produces coordinates of discovered objects, typically in form of rectangular bounding boxes around the detected objects. Saliency based detection methods using video motion may also be employed to identify important regions. For example, uniform motion that is detected across consecutive frames can be designated as salient. In another example, any motion that persists over long periods of time (for example 100 frames) in a continuous trajectory can be designated as salient. In another example, motion that is detected at the same coordinates at which the objects are detected can be designated as salient. Spatial coordinates of salient regions can be used to determine regions for packing and enable the identification of pixels deemed as unimportant to the detection module. Such unimportant regions may be discarded and not used in packing.

### Region Padding

The discovered objects and regions from region detector 412 may be additionally processed prior to the extraction and packing stage in order to enable more efficient compression and/or endpoint machine task performance. Detected object boundaries may be extended using region padding module 460. Padding is the expansion of the bounding box beyond the minimum area detected by one or more pixels in one or more directions or dimensions. Padding may be applied uniformly around a bounding box, e.g., the same number of pixels in each dimension, or dynamically where the padding varies in different dimensions.

Padding size may be determined based on internal decisions made by the module either with or without receiving adaptive padding parameters 464. This can include applying padding based on object class, object size, and/or object confidence. For example, the decision to enable padding and the amount of padding can be calculated using optimized search in the inference space which may compare the detection accuracy for boxes with or without padding, and with various amounts of padding applied. It will be appreciated that not all object classes and instances need to be evaluated. Representative samples of classes with similar characteristics such as size, orientation and color, can be used to assign padding decision for all the objects that are represented by the exemplary object.

Application of the padding module 460 can provide better context for post-compression machine task evaluation by the machine system at the decoder site. Each endpoint machine system may have varying sensitivities to background pixel information; thus, the extension of initially predicted regions can help to increase evaluation accuracy. The object padding described herein is preferably performed by expanding each dimension with respect to overall image boundaries in order to include additional pixels for context. Such additional pixels are ones which reside outside of the original coordinates output by the region detection module.

Prediction box extension may be performed using a fixed padding amount or can adaptively be determined on a box-by-box basis. Adaptive padding can be performed using the characteristics of the detected object including object class, inference confidence/score, and/or object size. Additionally, padding may be skipped based on the type of region detection method selected or using a similar box-by-box basis. Padding size may be determined with supplementary input adaptive padding parameters 464 based on machine task feedback.

### Region Extraction and Packing

The resulting extended/padded coordinates from padding module 460 serve as input to region extraction module 416. The region extraction module 416 extracts the image regions and prepares the coordinates for the packing module 420. The region packing module 420 takes the extracted region and packs them tightly into a single frame. The packing module 420 additionally outputs packing parameters that will be signaled later in bitstream 432.

### Video Encoding

Packed object frames are processed through video encoder 428 to produce a compressed bitstream. The video encoder 428 can take the form of any known advanced video encoder such as for use in encoding to standards such as HEVC, AV1, and VVC, or variations on such known standards for machine use. The compressed bitstream includes the encoded packed regions along with parameters 424 needed to reconstruct and reposition each region in the decoded frame. Optionally, the padding size used for each of the boxes may be signaled in the bitstream for use in decoder side reconstruction and for data collection. Such signaling may include signaling within a header, an SPS, PPS, or auxiliary signaling such as supplementary enhancement information (SEI).

While the various functional modules in encoder 408 have been described as distinct functional modules, it will be appreciated that these functional modules can be further divided into sub-modules or functionality combined without departing from the intent of the embodiments described herein.

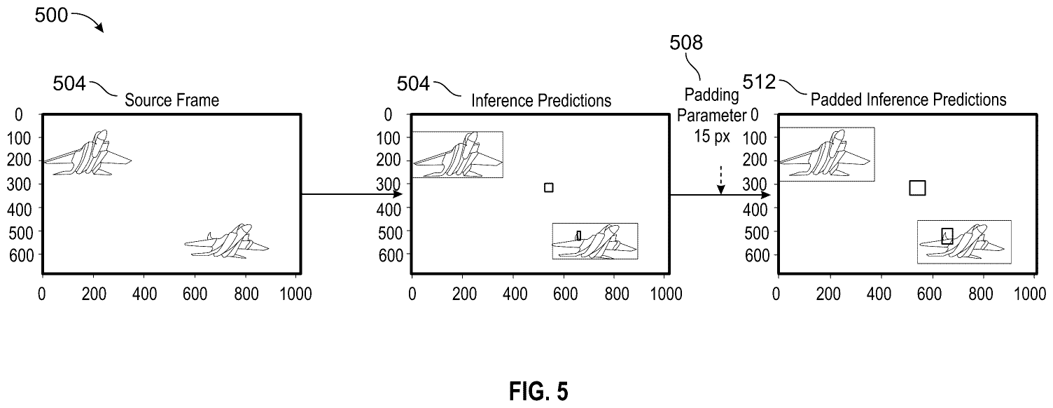

FIG. 5 is a pictorial representation of the present region padding where the source frame 504 is processed to provide four inference predictions, or objects in 506. A 15-pixel padding parameter is applied 508 to the four objects to provide the padded inference predictions illustrated in 510. While in this example a fixed padding was applied to each detected object, it will be understood that in different examples, adaptive padding may be applied in which a different padding parameter is applied to different detected objects.

### Video Decoding

The structure and operation of a decoder for the bitstream with region padding is substantially the same as illustrated in FIG. 2, except as described below. When region padding is used during encoding, the compressed bitstream 432 is decoded by video decoder 240 to produce a packed region frame along with its signaled region information. Such region information preferably includes region parameters 248 useful for reconstruction of the frame and may incorporate the padding size applied to each of the regions, determined by the encoder side processes.

### Region Unpacking

With reference to FIG. 2, the decoded parameters are used to unpack the packed region frames via region unpacking module 244. Each box is returned to its position within the context of the original video frame. The resulting unpacked frame 252 only includes the significant regions determined by the region detection system 412—post padding—and preferably does not include the discarded pixels outside the padded object boundaries. The signaled padding size from region parameters 248 may be used in the unpacking stage to determine background pixels. These background pixels can be used to improve object context and can aid in filling in empty space within the unpacked frame 252.

### Machine Task

The unpacked and reconstructed video frame 252 is used as input to machine task system 256 which may perform machine tasks, such as computer vision related functions. Machine task performance on the padded regions may be analyzed and used to determine optimal padding amounts on a box-by-box or object-by object basis. Optimized padding parameters 464 may be updated and signaled to the encoder side pipeline in order to effectively extend object boundaries.

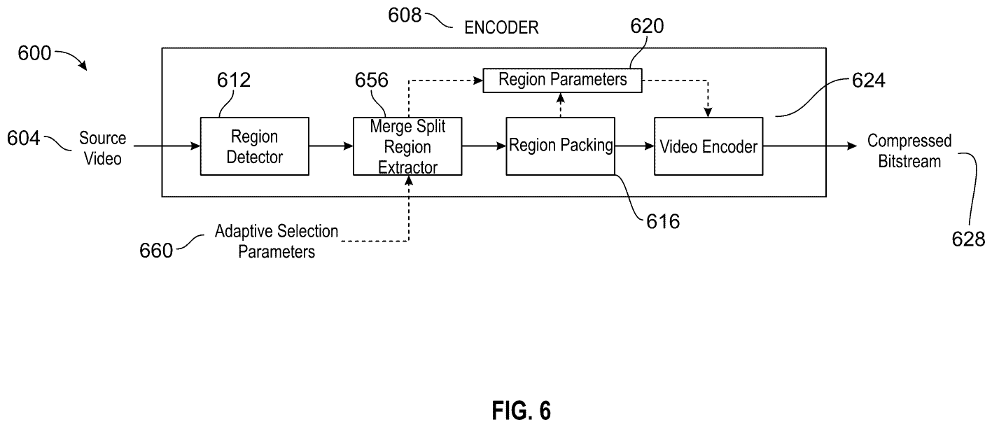

FIG. 6 is a simplified block diagram for an alternate embodiment of an encoder for region packing with merge/split region extraction for video coding for machines in accordance with the present disclosure. The encoder 600 processes received source video 604 and generates a compressed bitstream 628. The encoder 600 includes a region detection block 612, merge/split region extractor module 656, region packing module 616, region parameters module 620, and video encoder 624 which cooperate to generate a compressed bitstream 628. The encoder's constituent components of encoder 600 are similar in structure and operation to that described above in connection with FIG. 2, except as noted below.

### Merge Split Region Extraction

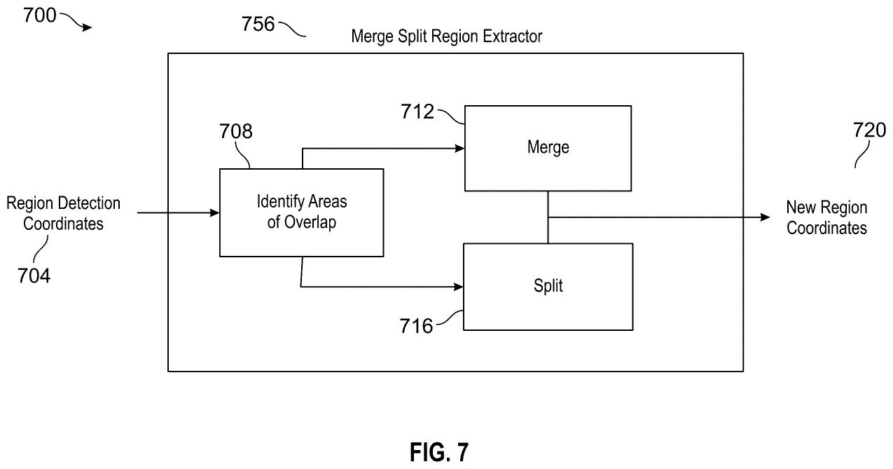

The merge split region extraction module 656 receives object coordinates from region detection system 612. These coordinates may contain multiple predictions within the same region and/or may consist of overlapping regions with redundant pixels. The merge/split extraction module 656, which creates new region boxes based on the given predictions, is further illustrated in FIG. 7.

Referring to FIG. 7, the merge split region extractor 756 receives region detection coordinates 704 from the region detection system 612. The merge split region extractor 756 identifies areas of overlap 708 in the detected regions and then merge actions 712 and split actions 716 may be applied to merge multiple region predictions into a single box and/or split regions into new smaller boxes defined by new region coordinates 720. These actions are performed on a per object (or per prediction) basis.

The merge split region extractor module 756 examines which regions are close in proximity and identifies them as candidates for further processing. The decision to merge and the decision to split is made primarily based on rate-saving considerations, and secondarily on the consideration of the expected detection accuracy on the machine. By merging region predictions, more compact and continuous spatial structures may be obtained which may be more amenable to predictive hybrid video and image coding. By splitting region predictions, smaller geometric structures, such as smaller rectangles are obtained which can potentially be packed in a spatially more optimal way. For example, in some cases, the machine detection performance can be improved if the bits that are saved by improved object packing are spent on more accurate texture representation (for example preserving more of the high frequency components).

Different criteria may be used to determine appropriate scenarios for merging and splitting actions. For example, inference prediction boxes which overlap beyond a determined threshold may be merged to form a single new region box. Here, the previous inference boxes may be discarded and replaced with the unified new box. Splitting may be performed on boxes that overlap with a smaller threshold. In this case, the split boxes are preserved while the original inference boxes may be discarded.

One or more region detections can be grouped into a local cluster. Machine learning methods may also be used to determine the optimal number of clusters based on given inference parameters and image characteristics. For example, each region detection can be designated as a single instance in the k-means clustering algorithm-a cost function that minimizes the bit budget to encode the frames, and/or a cost function that maximizes detection accuracy in the inference model, can be used as an objective function of the k-means algorithm.

Clusters of boxes may be merged to form regions which contain multiple inference objects. Additionally, a variety of splitting methods may be used on a case-by-case basis. This includes horizontal splitting, vertical splitting, and/or some combination of both. For instance, overlapping inference boxes which contain vertically oriented objects may be split vertically whereas horizontal objects may be split horizontally.

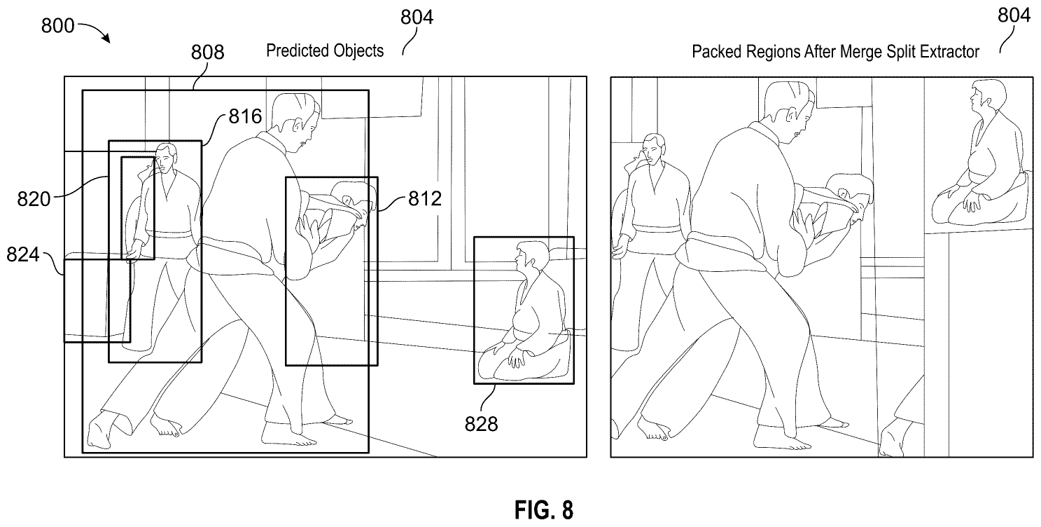

FIG. 8 shows an example of applied merging and splitting actions. Predicted objects in the original frame 804 are used as a basis to determine new region boxes. Predicted regions 808, 812, 816, and 820 overlap with one another by a significant amount and share many of same the image pixels. These objects are merged to form a new region box. The resulting merged coordinates still overlap with an existing inference prediction, box 824. Since the region of overlap is not as large as the previously described overlapping occurrences, these two regions are vertically split to create new smaller region boxes. Prediction 828 is left intact as it does not overlap with any other regions. The final boxes can be packed tightly as shown in 804.

Merging inference boxes may be beneficial to the encoding and machine task processes. Merged boxes may help to reduce the number of individual boxes sent to the packing system and consequently enable improved spatial preservation of image objects. Alternatively, splitting overlapping boxes helps to reduce occurrences of duplicate pixels propagated throughout the pipeline. The region extraction step performed by merge split region extractor 656 may include additional pixels outside of what was determined to be significant by the region detection module 612. It may additionally change which pixels are to be discarded. The system outputs new region coordinates 720.

### Region Packing

The newly identified region box coordinates 720, returned from the merge split extraction module 656, serve as input to the region packing system 616. The region packing module 616 extracts the significant image regions and packs them tightly into a single frame. The region packing module produces packing parameters that will be signaled later in the encoded bitstream 628.

### Video Encoding

Packed object frames which contain the processed regions from 656 are input to video encoder 624 which produces a compressed bitstream 628. The compressed bitstream includes the encoded packed regions along with parameters 620 needed to reconstruct and reposition each region in the decoded frame. Optionally, original region coordinates (i.e., those derived from inferences from region detector 612, prior to merge split region extraction 656) may be signaled in bitstream for decoder side usage.

### Video Decoding

The compressed bitstream 628 is decoded using video decoder 236, substantially described in FIG. 2, to produce a packed region frame along with its signaled region information. Such region information includes parameters needed for reconstruction of the frame and may incorporate the original object coordinate information from 612 along with the new coordinates and region information 720 provided by merge and split region extractor 656.

### Region Unpacking

The decoded region parameters 248 are used by region unpacking module 244 to unpack the packed region frames. Each box is returned to its position within the context of the original video frame. The resulting unpacked frame only includes the significant regions determined by the region detection system 112 after merge split extractor module 656 and preferably does not include the discarded pixels.

### Machine Task

The unpacked and reconstructed video frame 252 is used as input to machine task system 256 which may perform machine tasks, such as computer vision related functions. Machine task performance on the regions determined by the merge split extraction module 656 may be analyzed to determine optimal extraction actions. Optimized region extraction parameters 660 may be updated and signaled to the encoder side pipeline in order to effectively merge and split the inference boxes to identify regions.

Some embodiments may include non-transitory computer program products (i.e., physically embodied computer program products) that store instructions, which when executed by one or more data processors of one or more computing systems, cause at least one data processor to perform operations herein.

Embodiments may include circuitry configured to implement any operations as described above in any embodiment, in any order and with any degree of repetition. For instance, modules, such as encoder or decoder, may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoders and decoders described herein may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Non-transitory computer program products (i.e., physically embodied computer program products) may store instructions, which when executed by one or more data processors of one or more computing systems, causes at least one data processor to perform operations, and/or steps thereof described in this disclosure, including without limitation any operations described above and/or any operations decoder and/or encoder may be configured to perform. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A video encoder for encoding data for machine consumption comprising:
a region detector selection module receiving source video and detector selection parameters and selecting an object detector model;
a region detection module, the region detection module receiving the selected object detector model and applying said model to the source video to identify regions of interest in the source video;
a region extractor module extracting the identified regions from the source video;
a region packing module, the region packing module receiving the extracted regions from the source video and packing said regions into a packed frame;
a region parameter module, receiving the identified regions from the region extractor and providing parameters for placing the regions in a reconstructed video frame; and
a video encoder, the video encoder receiving a packed frame from the region packing module and region parameters from the region parameter module and generating an encoded bitstream.

2. The encoder of claim 1, wherein the region detector selection module selects one of a plurality of models based on detector selection parameters from a machine task system.

3. The encoder of claim 2, wherein the detection selection parameters from the machine task system are updated based on the performance of the machine task system to the encoded bitstream.

4. The encoder of claim 2, wherein the plurality of models include at least one of a RetinaNet model and a Yolov7 model.

5. The encoder of claim 1, wherein the region detection module defines each detected region at least in part by a rectangular bounding box and the encoder further comprising a region padding module, the region padding module adding a padding parameter to one or more dimensions of a bounding box of a detected region.

6. The encoder of claim 5, wherein each detected region has an associated region type and the padding parameter is determined at least in part based on the object type.

7. The encoder of claim 5, wherein the padding parameter is determined at least in part on region size.

8. The encoder of claim 1 further comprising a merge split region extractor module, the merge split region extractor module processing detected regions for further processing and performing at least one of selectively merging regions with substantial overlap and selectively splitting regions to optimize packing performance.

9. The encoder of claim 8, wherein the merge split region extractor module receives adaptive extraction parameters from a machine task system and dynamically adjusts merge and split parameters based on said parameters.

10. The encoder of claim 1, wherein each detected region is defined by a rectangular bounding box, the encoder further comprising:
a region padding module, the region padding module adding a padding parameter to one or more dimensions of a bounding box of a detected region; and
a merge split region extractor module, the merge split region extractor module processing detected regions for further processing and performing at least one of selectively merging regions with substantial overlap and selectively splitting regions to optimize packing performance.

11. A method of encoding video data for consumption by machine processing, the method comprising:
receiving source video;
identify at least one region of interest in the source video, each region of interest defined by an associated bounding box;
extracting identified content of the regions of interest within the associated bounding box from the source video;
packing the extracted regions into a packed video frame in which pixels outside the regions of interest are omitted;
providing region parameters for the bounding boxes sufficient to reconstruct the regions of interest in a reconstructed video frame; and
generating an encoded bitstream including the packed frame and associated region parameters.

12. The method of encoding of claim 11, further comprising:
for at least one region of interest, apply region padding to at least one dimension of the associated bounding box; and
apply merge split processing comprising at least one of selectively merging regions of interest with substantial overlap and selectively splitting regions to optimize packing performance.

13. The method of encoding of claim 12, wherein a region of interest has an associated object type and the region padding is determined at least in part on the object type.

14. The method of encoding of claim 12, wherein a region of interest has an associated bounding box size and the region padding is determined at least based on the bounding box size.

15. The method of encoding of claim 12, further comprising receiving performance data from a machine system at a decoder site receiving the encoded bitstream and wherein the region padding is determined at least in part based on the received performance data.
